(19) United States
(12) Patent Application Publication
(10) Pub. No.: US 2015/0038623 A1
(43) Pub. Date: Feb. 5, 2015

(54) COMPOSITIONS AND METHODS FOR IMPROVING FLUID-BARRIER PROPERTIES OF POLYMERS AND POLYMER PRODUCTS

(71) Applicants: Louis F. Gatti, Newark, DE (US); Richard Douglas Carter, Macon, GA (US)

(72) Inventors: Louis F. Gatti, Newark, DE (US); Richard Douglas Carter, Macon, GA (US)

(73) Assignee: KAMIN LLC, Macon, GA (US)

(21) Appl. No.: 14/128,857

(22) PCT Filed: Jun. 20, 2012
(86) PCT No.: PCT/US2012/043214

§ 371 Date: Mar. 6, 2014

Related U.S. Application Data
(60) Provisional application No. 61/501,014, filed on Jun. 24, 2011.

(51) Int. Cl. C08K 3/34; C08K 13/02

(52) U.S. Cl. CPC C08K 3/346; C08K 13/02
USPC 524/186; 524/447

(57) ABSTRACT

In some variations, this disclosure provides compositions for reducing fluid permeability through a polymer membrane, the composition comprising a polymer (e.g., bromobutyl rubber) and mineral particles (e.g., kaolin particles) including fine particles with particle sizes between about 0.05 μm and about 1 μm and coarse particles with particle sizes between about 3 μm and about 20 μm. Applications for these improved-barrier polymers include tire innerliners, paint and paper coatings, films, adhesives, liners, paints, and hoses, for example. Methods of making and use these polymers are also disclosed.

### PRIORITY DATA

This international patent application claims priority to U.S. Patent App. No. 61/501,014, filed Jun. 24, 2011 for COMPOSITIONS AND METHODS FOR IMPROVING FLUID-BARRIER PROPERTIES OF POLYMERS AND POLYMER PRODUCTS, which is hereby incorporated by reference herein.

### FIELD

This patent application relates to improving barrier properties in polymers and polymer-containing products, to reduce the permeation of fluids (where a fluid is meant to include any mobile phase such as a gas or liquid).

### BACKGROUND

It is known that the use of a kaolin clay in place of carbon black at equal PHR or higher replacement (i.e. equivalent volume, equivalent surface area, etc.) reduces the rate of air permeation through a polymeric membrane (see, e.g., U.S. Pat. No. 4,810,578). It is believed the improvement is from the presence of a high aspect ratio, e.g. platy, material, in contrast to the porous aggregated particle cluster of carbon black.

Carbon black is generally included in a highly elastic polymeric material to provide reinforcing properties such as modulus, tensile strength, tear resistance, and aid in obtaining desired processing characteristics. A platy filler, which is often described as having a high aspect ratio, can be introduced to improve the permeation resistance but comes at the expense of these desired reinforcing properties that carbon black produces. Unfortunately, the nature of the carbon black can also contribute to the disrupting of the packing of a platy filler thereby reducing its effectiveness. It would be desired to optimize the filler to allow lower fluid permeation rates and/or concomitant reductions in material usage but this has been limited by the need to balance the polymers properties.

Furthermore, there is generally a need in the marketplace for improved barrier properties associated with polymers, polymer membranes, and products incorporating such polymers either as a discrete layer or as a portion of a composite material formulation. Improved barriers to reduce the permeability of a variety of fluids (gases and liquids) are needed in a wide variety of commercial applications, including but not limited to air permeation through vehicle tires, and liquid and air permeation in food packaging.

### SUMMARY OF THE DISCLOSURE

In some variations, this disclosure provides a composition for reducing fluid permeability through a polymer membrane, the composition comprising a polymer and from about 10 to about 100 parts per hundred of mineral particles, wherein the mineral particles include fine mineral particles with particle sizes between about 0.05 μm and about 1 μm and coarse mineral particles with particle sizes between about 3 μm and about 20 μm, and wherein the weight ratio of the fine mineral particles to the coarse mineral particles is selected from about 0.1 to about 10.

In some embodiments, the composition comprises from about 15 to about 100 parts per hundred of mineral particles, such as from about 40 to about 70 parts per hundred of mineral particles or from about 50 to about 60 parts per hundred of mineral particles.

In some embodiments, the weight ratio is selected from about 0.2 to about 10, such as about 0.2 to about 5, or about 2.5 to about 3.5. The weight ratio may be selected to balance gas-barrier and strength properties associated with a particular composition.

In some embodiments, the coarse mineral particles constrain the movement of the fine mineral particles. For example the coarse mineral particles may limit the ability of the fine mineral particles to rotate in the presence of a shear field. Or the coarse mineral particles may cause alignment of the fine mineral particles or vice versa.

This disclosure also provides a composition for reducing fluid permeability through a polymer membrane, the composition comprising a polymer and mineral particles, wherein:

the mineral particles possess a bimodal particle-size distribution;

the bimodal particle-size distribution includes a first peak diameter and a first peak population associated with fine mineral particles and a second peak diameter and a second peak population associated with coarse mineral particles;

the first peak diameter is from about 0.05 μm to about 1 μm;

the second peak diameter is from about 3 μm to about 20 μm; and

the weight ratio of the fine mineral particles to the coarse mineral particles is from about 0.1 to about 10.

In some embodiments, the particle-size distribution is measured by laser light scattering, and/or by using the average Stokes-equivalent particle diameters for the fine and coarse mineral particles. The first peak population may be smaller or larger than the second peak population.

In some embodiments, the first peak diameter is in the range of about 0.1 μm to about 0.8 such as about 0.2 μm to about 0.5 μm. The second peak diameter is in the range of about 5 μm to about 10 in some embodiments, such as about 6.5 μm to about 8.5 μm. Larger particles (such as particles larger than 20 μm) may also be present.

The mineral particles may have a calculated average specific surface area (measured by laser light) in the range of about 1 m²/g to about 5 m²/g, such as about 1.5 m²/g to about 3.5 m²/g, or as measured by BET in the range of 8-28 m²/g, such as about 12-22 m²/g, for example.

The mineral particles may be clay mineral particles. In some embodiments, the mineral particles are selected from the group consisting of ball clay, kaolin, talc, mica, calcite, dolomite, alumina, silica, alumina-silicates, mineral zeolites, pyrophyllite, vermiculite, lime, gypsum, and any polymorph or mixture thereof. The mineral particles may be selected from the Kaolin group of minerals comprising kaolinite, dickite, halloysite, nacrite, montmorrilite, or any other polymorph of Al₂Si₂O₅(OH)₄. In certain embodiments, the mineral particles consisting essentially of kaolin particles.

The polymer may be a thermoset elastomer, such as a polymer selected from the group consisting of butyl rubber, halobutyl rubber, nitrile rubber, natural rubber, neoprene rubber, ethylene-propylene-diene-monomer rubber, polybutadiene, poly(styrene-butadiene-styrene), and any combination thereof. In certain embodiments, the polymer is bromobutyl rubber.

The polymer may be a thermoplastic polymer, such as a polymer selected from the group consisting of homopolymers or co-polymers of polypropylene, polyethylene, polystyrene, poly(acrylonitrile-butadiene-styrene), poly(methyl methacrylate), poly(vinyl chloride), poly(vinyl acetate), styrene-butadiene block copolymer, polylactide, and any combination thereof. The polymer may also be a thermoplastic vulcanizate.

The composition may further include carbon black, carbon nanotubes, or another form of carbon particles. The composition may also include a coupling agent, a dispersing aid, or a viscosity modifier.

The present disclosure also provides a composition for reducing fluid permeability through a polymer membrane, the composition comprising a bromobutyl polymer, carbon black, and from about 25 to about 100 parts per hundred of mineral particles, wherein the mineral particles include fine mineral particles with particle sizes between about 0.05 μm and about 1 μm and coarse mineral particles with particle sizes between about 3 μm and about 20 μm, and wherein the weight ratio of the fine mineral particles to the coarse mineral particles is selected from about 0.1 to about 10. The composition may further comprise stearic acid, magnesium oxide, dimethylalkyl tertiary amine, naphthenic oil, zinc oxide, and sulfur.

In some embodiments, a composition as provided herein is characterized by a gas permeability of about 4×10⁻¹³ (cm³·cm/(cm²·sec·Pa)) or less as measured in accordance with ASTM D-1434-82 (2003), Procedure V, using air at a temperature of 70° C., gas pressure of 35 psi, permeation area 66.4 cm², and capillary diameter of 0.0932 cm, on a test sample cured to a gauge of 0.020″ for 10 minutes at 160° C. The gas permeability may be about 3.3, 3.2, 3.1, 3×10⁻¹³ (cm³·cm/(cm²·sec·Pa)) or less.

In some embodiments, a composition as provided herein is characterized by an aged tensile strength of at least 1300 psi as measured in accordance with ASTM D-412 on a test sample cured for 20 minutes at 160° C. and then aged for 48 hours at 100° C. in accordance with ASTM D-573. The aged tensile strength is at least 1400 psi, 1450 psi, or 1500 psi, in some embodiments.

A composition is provided, comprising a polymer, carbon particles, and from about 40 to about 70 parts per hundred of fine mineral particles with particle sizes between about 0.05 μm and about 1 wherein the composition provides a gas permeability of about 4×10⁻¹³ (cm³·cm/(cm²·sec·Pa)) or less as measured in accordance with ASTM D-1434-82 (2003), Procedure V, using air at a temperature of 70° C., gas pressure of 35 psi, permeation area 66.4 cm², and capillary diameter of 0.0932 cm, on a test sample cured to a gauge of 0.020″ for 10 minutes at 160° C.; and an aged tensile strength of at least 1300 psi as measured in accordance with ASTM D-412 on a test sample cured for 20 minutes at 160° C. and then aged for 48 hours at 100° C. in accordance with ASTM D-573.

A composition is provided, comprising a polymer, carbon particles, and from about 40 to about 70 parts per hundred of fine mineral particles with particle sizes between about 0.1 μm and about 1 wherein the composition provides reduced gas permeability and increased tensile strength compared to an otherwise-equivalent composition without the fine mineral particles.

The present disclosure additionally provides a polymeric membrane for resisting fluid permeation, the polymeric membrane comprising a composition in accordance the described compositions.

In some embodiments, the fluid whose permeability is reduced is any gas, including but not limited to air, oxygen, nitrogen, carbon monoxide, carbon dioxide, methane, water vapor, or any mixture thereof. In some embodiments, the fluid whose permeability is reduced is a liquid, such as an aliphatic or aromatic hydrocarbon, a polar hydrocarbon, or a water-based liquid.

The disclosure also provides products incorporating the disclosed compositions, such as tire innerliners, coatings, plastic extrusions, films, liners, adhesives, paints, hoses, or weather-protection materials or systems.

This disclosure also provides a method of fabricating a polymeric membrane for resisting fluid permeation, the method comprising:

(a) providing a polymer;

(b) providing mineral particles with a selected amount of fine mineral particles with particle sizes between about 0.05 μm and about 1 μm and a selected amount of coarse mineral particles with particle sizes between about 3 μm and about 20 μm, wherein the weight ratio of the fine mineral particles to the coarse mineral particles is from about 0.1 to about 10;

(c) combining from about 10 to about 100 parts per hundred of the mineral particles with the polymer, to form a polymer-particle mixture; and

(d) forming a polymeric membrane from the polymer-particle mixture under effective processing conditions, whereby the polymeric membrane includes the mineral particles in a form that provides a barrier against fluid permeation through the polymeric membrane.

In some embodiments, the method further comprises introducing a dispersing aid (e.g., an alkyl tertiary amine, polyacrylate, TSPP, silane-based chemicals or other suitable dispersants) into the polymer-particle mixture. The method may include liberating freely associated water on the surface of the mineral particles when incorporated into hydrophobic polymers. Liberated water may be replaced by a dispersing aid. In some embodiments, liberating freely associated water prevents blisters or other defects during step (d). In other cases the dispersant may be working to ensure wetting of the surface of the mineral by the polymeric material such that air is not entrained in the final product. It may be necessary as well when processing liquid polymers to remove the air prior to application.

In some embodiments, the method further comprises introducing a coupling agent into the polymer-particle mixture. The method may include chemically treating at least a portion of the mineral particles with one or more functional organic groups. Functional organic groups may be selected to repel the fluid, provide crosslinking or adsorption to the polymer, adjust the hydrophilic-lipophilic balance of the polymer, and/or adjust viscosity of the polymer-particle mixture.

The method may further comprise chemically treating at least a portion of the mineral particles with a silane, a titanate, a grafted maleic anhydride, and any combination thereof.

The disclosure also provides a method of fabricating a polymeric membrane for resisting fluid permeation, the method comprising producing a composition as set forth herein, and then forming the polymeric membrane, at least in part, from the composition.

### BRIEF DESCRIPTION OF THE FIGURES

FIG. 1 summarizes the compositions according to Examples A, B, and C.

FIG. 2 shows particle-size data for the kaolins used in Examples B and C.

FIG. 3 shows experimental data associated with Examples A, B, and C.

FIG. 4 summarizes the compositions according to Examples D and E.

FIG. 5 shows particle-size data for the kaolins used in Examples D and E.

FIG. 6 shows experimental data associated with Examples D and E.

FIG. 7 lists viscosity test data for Examples A, B, C, D, and E.

FIG. 8 summarizes the compositions according to Examples F, G, and H.

FIG. 9 shows experimental data associated with Examples F, G, and H.

FIG. 10 shows particle-size data for the kaolin particle blends used in Examples F, G, and H.

FIG. 11 illustrates reduced gas permeability in some embodiments.

FIG. 12 illustrates enhanced tensile strength in some embodiments.

### DETAILED DESCRIPTION OF SOME EMBODIMENTS

This description will enable one skilled in the art to make and use the principles of the disclosure, and it describes several embodiments, adaptations, variations, alternatives, and uses of the disclosure.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs. As used herein, a “composition,” “blend,” “compound,” or “mixture” are all intended to be used interchangeably.

Unless otherwise indicated, all numbers expressing parameters, conditions, concentrations, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The Examples described herein are examples of the disclosure, including examples of various embodiments as well as comparative examples (such as Example A). None of the examples should be construed as limiting the principles of the invention, or its application, in any way. All examples are exemplary only.

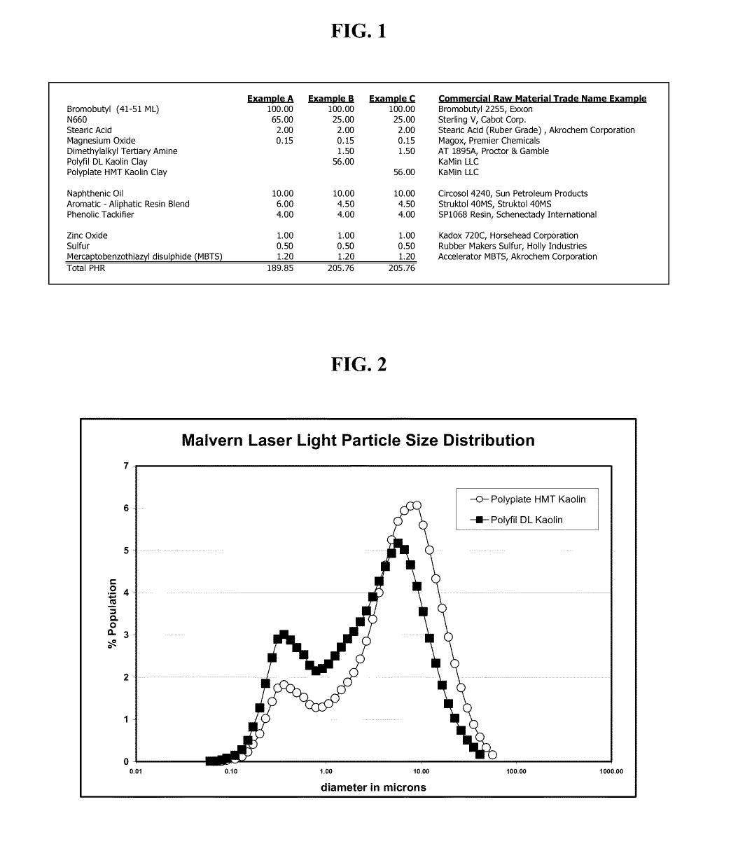

The present inventors studied the replacement of carbon black in a bromobutyl rubber formula similar to formulas referenced in the literature (such as, for example, U.S. Pat. No. 7,019,063). The formula is illustrated in the table of FIG. 1, with the carbon black formula being Example A. Examples B and C compare two different delaminated kaolin clays replacing the carbon black at an equal volume replacement in the rubber compound.

The particle-size distribution of these two kaolins (Polyfil® DL and Polyplate® HMT, KaMin LLC, Macon, Ga., US) was measured using a Malvern laser light-scattering device. These results are illustrated in FIG. 2. From this graph, we can see that the Polyplate HMT has a higher percentage of larger-diameter particles and less finer particles than the Polyfil DL. It may be that this indicates that the kaolin in Example C is “platier.” The term “platy” refers to particle aspect ratio, wherein a platier particle has a higher aspect ratio (plate-like). Platy particles may be naturally platy or may derive from layered structures that are separated mechanically.

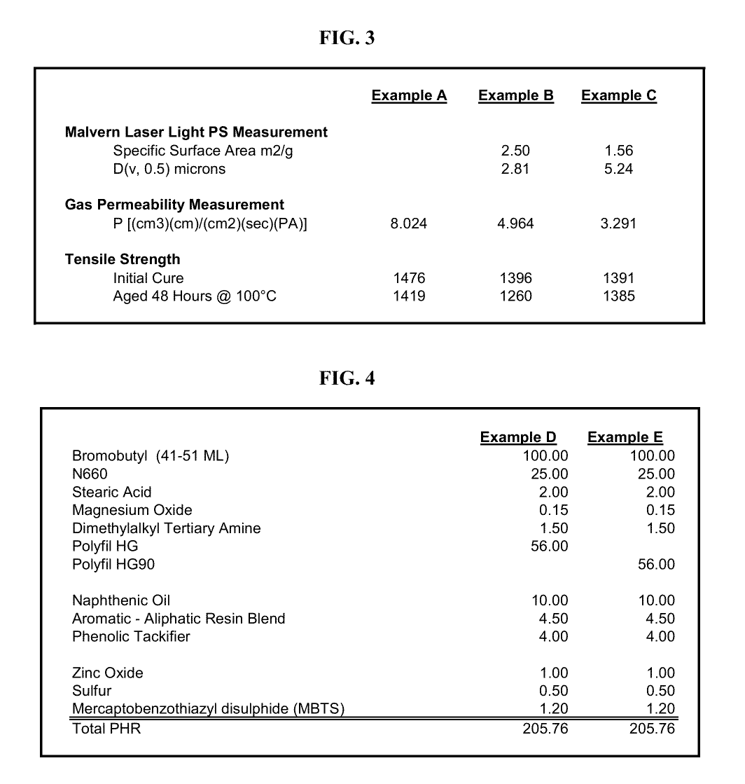

Reported in FIG. 3 are the surface area and average particle size by the Malvern device; the lower surface area and larger particle size, it may be that it is indicative of larger, platier kaolin. FIG. 3 shows that both platy kaolin-filled bromobutyl compounds have reduced gas permeation relative to that of the carbon black only compound (Example A). Example C is found to reduce gas permeation by 34% relative to the smaller platier pigment. However, the tensile strength test shows that both kaolin examples produce lower tensile strength than the carbon black filled Example A.

Traditionally, highly platy kaolins have been derived from coarse sedimentary or coarse primary deposits. The two Examples B and C are representative of that type. There also exist in sedimentary deposits finer particle size kaolins that can be extracted either from a mine that is finer in nature or through a fractionation process on a coarser reserve. Generally speaking, the finer the particle size of a filler, the higher the reinforcement of a flexible polymer (such as bromobutyl) would be expected. While this might allow the use of a finer particle kaolin without the impact on strength, historically these types of fine particle materials have been avoided for barrier applications due to the perception that one needed a large plate to create an appropriate barrier. However, fine particles may allow equal performance to be achieved by allowing higher loading level. We examined these types of clays in the formulas in FIG. 4, Examples D and E.

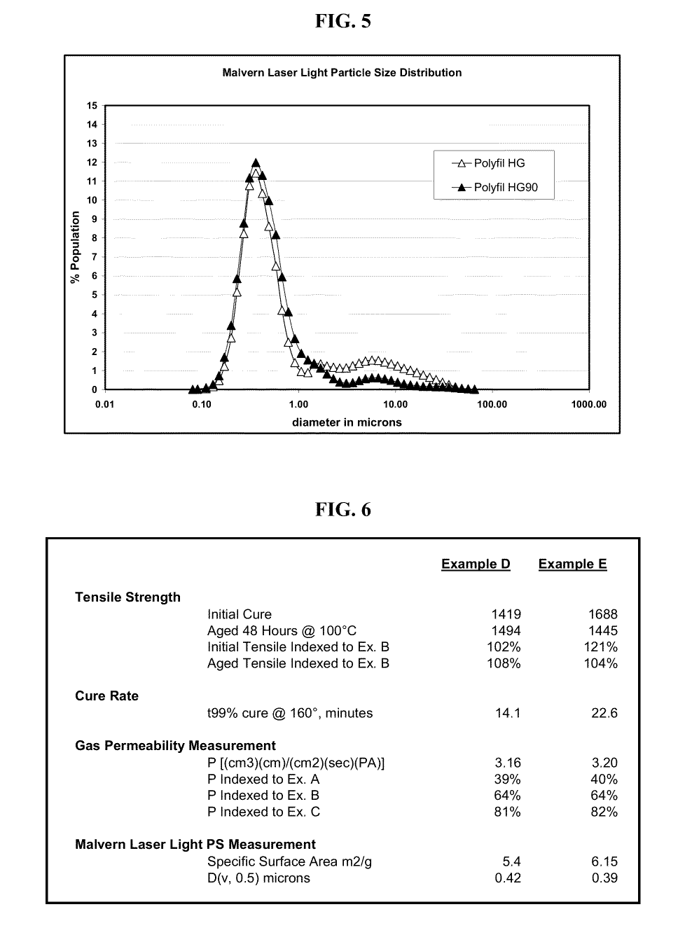

The Malvern particle size distribution for the kaolins in Examples D and E are illustrated in FIG. 5. A preponderance of fine particles below one micron makes up the majority of the population. The expectation for these Examples D and E is that the fine kaolins would improve the reinforcement as measured by the rubber tensile strength. The resultant effect on tensile strength may guide their use in formulating for both strength and gas permeation resistance, in some embodiments.

FIG. 6 reports the testing of the rubber physical properties, rubber membrane air-permeation resistance, and the Malvern particle sizing of the respective kaolins used in Examples D and E. From this data, at the same loading level the fine particle kaolins do not impact the rubber strength as much as the larger kaolins in Examples B and C. Indeed, the tensile strength of Example E is favorably comparable to the carbon black Example A.

In contrast to conventional thinking, we observed that the gas-permeation resistance was improved not only versus the carbon black (Example A) but also was equal to or improved over both of the coarser platy clays (Examples B and C). This result is surprising because conventional wisdom would imply that finer kaolin particles do not offer good fluid barrier.

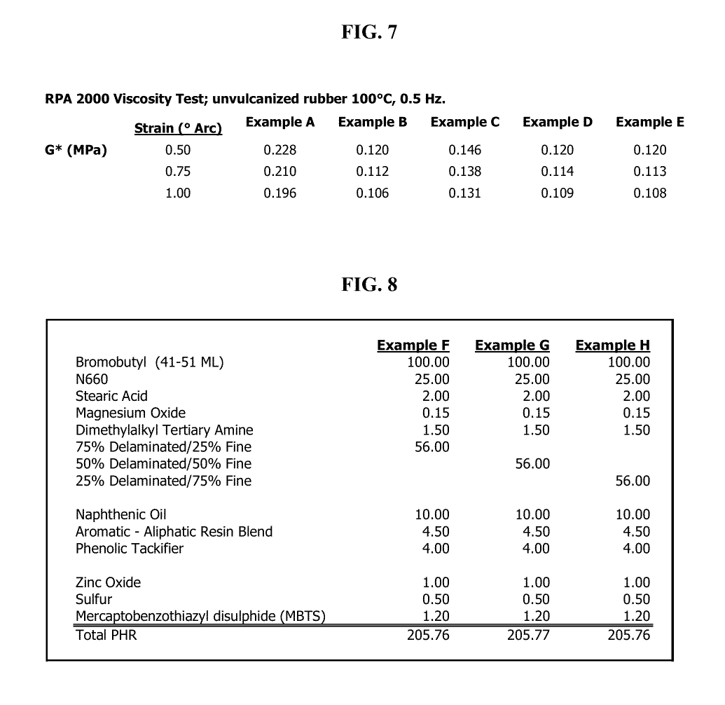

One benefit of the coarser kaolin, Polyplate HMT kaolin (Example C), was that it produced a slightly higher uncured viscosity relative to the Polyfil DL kaolin (Example B) rubber compound. This may be a desirable trait as the use of a non-black filler may create the need for accommodating the effect of viscosity on processing for certain types of equipment, in some embodiments. The two finer particle kaolins in Example D and E had viscosities similar to the Polyfil DL kaolin, Example B. These measurements are listed in FIG. 7.

It was of interest to examine whether a benefit in viscosity (i.e., increasing the viscosity) could be achieved by using blends of the coarser and finer particles. Some example formulas are described in FIG. 8.

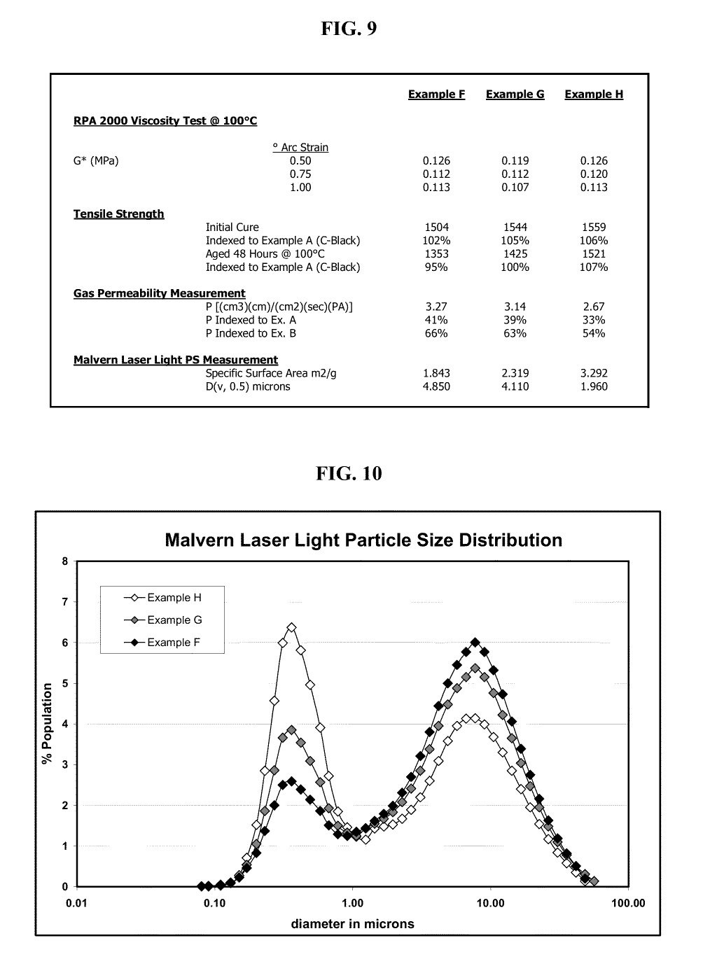

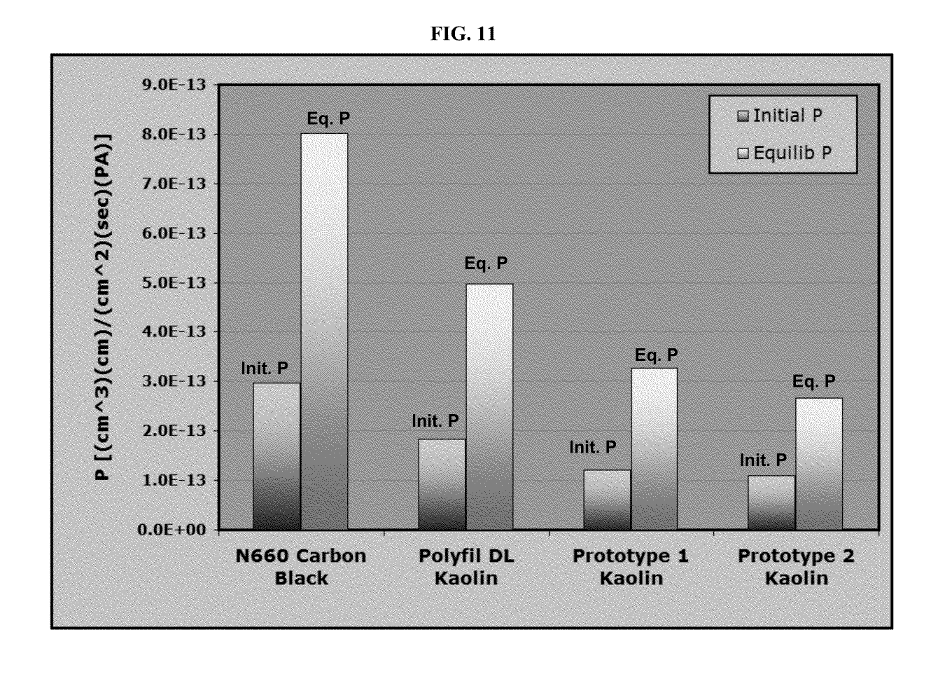

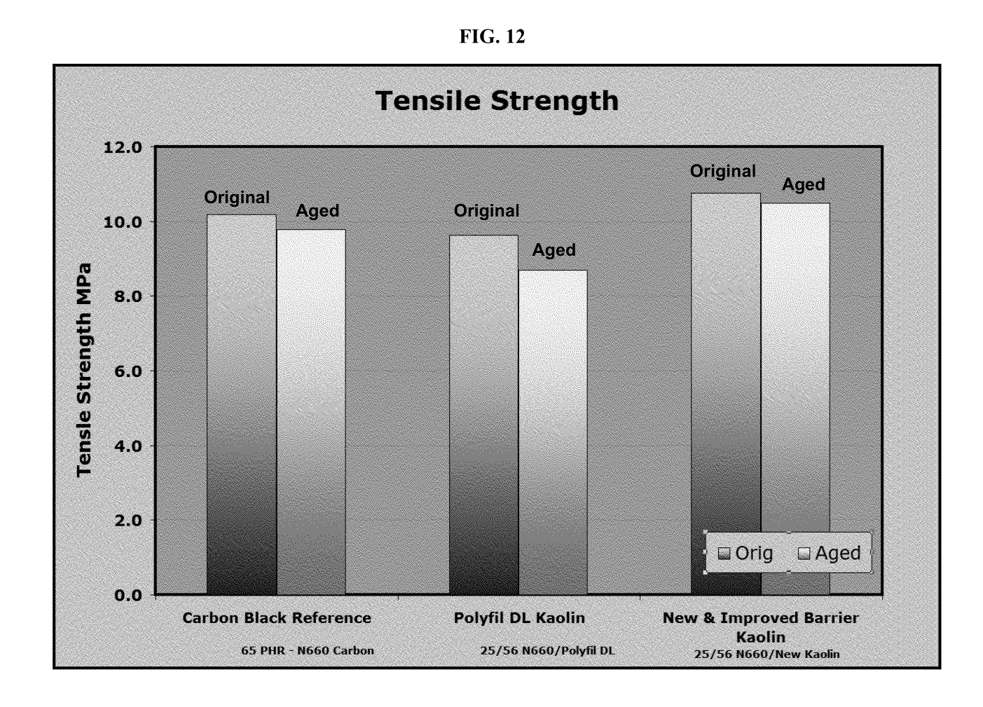

The experimental findings for these blends of kaolins in Examples F, G, and H are illustrated in FIGS. 9 and 10. The viscosity for these three compounds was reduced from the 100% Polyplate HMT kaolin in Example C but still comparable to the commercial Polyfil DL kaolin in Example B. The tensile strength for these blends is surprisingly favorable versus the carbon black (Example A), despite the presence of the coarser material in the blend.

Another surprise is that the blends were quite favorable with respect to gas-permeation resistance. Each of Examples F, G, and H appear to increase a torturous path through which a permeating fluid (e.g., air) must flow, thereby reducing the permeation rate.

With respect to gas barrier, Example H is a particularly good compound. Without being limited by any particular hypothesis, it is speculated that a small amount of large particles helps keep the smaller platy particles better aligned during the component fabrication on a mill, extruder, or calendar or in application techniques due to flow properties. A model of the flow would be one of constraint. If one models the flow of plate-like particles that are flowing in a constrained space, the larger the particle the better the alignment as the larger particles tend to streamline with the flow. By using some coarser particles, the flow of the finer particles are constrained by keeping them in plane and limiting their ability to rotate in the shear field. Alternatively, or additionally, a proportional amount of large particles may help overcome the layering of platy materials as impacted by the aggregated carbon black. Another theory (without limitation of the disclosure) is that the barrier process is driven by maximizing the number of plates in the system. If all plates are similar thickness, then the way get the most in there is to make them as small as possible and get them aligned, using coarse particles and limit the impact on strength.

Some embodiments are premised on the surprising discovery that a blend of a very fine and a coarse platy material reduce the permeation rate of a fluid through a polymer.

The impact this approach has on strength is likely not limited to tensile strength. It is believed that the use of a finer platy material improves bending strength while improving elasticity of the coating as it is bent by allowing for more dissipation of bending energy and less out of plane failures. The resultant coating should be much less subject to cracking at the point of bending than other barrier coatings utilizing coarser platy material. This is particularly important when barrier properties need to retained on a flexible packaging substrate.

In some embodiments, a composition for reducing fluid permeability through a polymer membrane is provided, the composition comprising a polymer and from about 10 to about 100 parts per hundred of mineral particles, wherein the mineral particles include fine mineral particles with particle sizes between about 0.1 μm and about 1 μm and coarse mineral particles with particle sizes between about 3 μm and about 20 μm.

The weight ratio of fine mineral particles to coarse mineral particles is selected from about 0.1 to about 10. One skilled in the art will understand that the ratio can be adjusted to make up for any changes in the particle sizes themselves. Preferably, the particles do not have a very broad particle size, to avoid significant strength loss. In some embodiments, enough coarse particles are introduced to force alignment of fine particles, without negatively impacting strength.

For those skilled in the art of formulating organic-based barrier systems, the principles of the disclosure may be applied to other polymeric systems such as thermoset elastomers (examples include but are not limited to: halobutyl, butyl, EPDM, NBR, neoprenes, natural rubber, polybutadienes, styrene-butadiene, etc. either used alone of in blends); thermoplastics polymers (examples include but are not limited to: homopolymers or copolymers of polypropylene, polyethylene, polystyrene, ABS, PMMA, PVC, PVA, SBR, etc.); and thermoplastic vulcanizates which are polymeric blends of thermoset and thermoplastic polymers.

Those familiar with the art of using platy fillers would understand that particles of other composition such as talc, mica, etc. used in a similar blend would also produce a similar improvement in permeation resistance. The blend could be with two or more types of platy materials as well such as kaolin and talc, kaolin and mica, or mica and talc, for example.

Other fine fillers may work to help the coarser fillers pack in more tightly. Preferably, the surface of the fillers should be compatible with the matrix. Multi-pigment blends may also work to enhance performance. Very fine particles help maintain strength.

Similarly, those familiar with the art would also expect that this surprising increase in the permeation resistance for the air extends to other gas forms (including water vapor) and also to liquids (organic or aqueous based liquids).

To further take advantage of this surprising effect for a variety of fluids, the platy materials can be treated with silanes, titanates, grafted maleic anhydride, etc. The inorganic side of the material would either bond or adsorb onto the platy filler blend and the other functional side would be chosen to reduce the compatibility of the platy filler surface to that fluid. The chemical treatment could be a blend of different types of chemical treatments (inorganic side) and could be a blend of different functional organic end to combine: repelling the permeating gas or fluid, provide crosslinking or strong adsorption to the polymer system to reduce swelling of the capillary path, and to control the hydrophilic-lipophilic balance functionality of the filler surface for processing viscosity during production (as an example). Surface treatment can help retard permeation rates by not wicking permeate, by crosslinking into matrix to help minimize swelling of capillary path.

If the platy filler is more hydrophilic than hydrophobic, a dispersing aid (instead of a coupling agent as described above) may be used in the formulation to improve the wetting out of the platy filler in the organic polymer complex. Dimethylalkyl tertiary amine is one such dispersing aid; for those skilled in the art, a number of materials could be used for this modification.

In some embodiments, the mixing protocol may be adjusted to allow for the liberation of the freely associated water on the surface the surface of the platy filler. During the processing with the hydrous platy material and dispersing aid present in the polymeric matrix, the temperature of the mix is above 100° C. for sufficient time to liberate the associated moisture and allow replacement by the dispersing aid. The dispersing aid dosage should be proportional to the surface area of the total platy filler being used that is hydrophilic and cover enough of the platy material surface to maintain the contained moisture below a level where blisters or other type of defects may form during subsequent fabrication steps of component or final product. If the platy filler is hydrophilic, steps may need to be taken to remove adsorbed water for defect free processing (e.g. blisters).

Dispersing aids include traditional dispersing aids or inorganic and organic nature including but not limited to: sodium silicate, sodium phosphate, lignin based dispersents, organic wetting agents and surfactants, polyacrylates, silane (traditionally used as coupling agents but can also be thought of as dispersants), animal and vegetable based oils and fats and fatty acids, proteins etc. In fact any product that allows the kaolin to be more compatible with the surround matrix may serve as a dispersant.

It is well known that increasing the total platy filler content increases the permeation resistance of a polymeric material such as bromobutyl polymer (up to a limit that is defined by the point at which the polymeric substance not longer can wet all the filler that is put into the polymeric material. Increasing the platy filler enhances the permeation resistance. However, one might find that the compound viscosity drops. In these cases, one skilled in the art will understand that decreasing levels of carbon black can suggest using a finer, more-reinforcing carbon black or other forms of carbon, or precipitates of fumed silicate to maintain the viscosity for the existing processing equipment. It is well known that as the carbon black type gets finer, the maximum tensile strength attainable increases and occurs at a lower loading level. Therefore, one knowledgeable in the art of formulation might choose an N300 or N200 series carbon black in lieu of the traditionally used N600 type carbon black, for example.

Carbon forms that may be suitable include, for example, carbon black; natural graphites, such as flaky graphite, plate-like graphite, and other types of graphite; high-temperature sintered carbon products obtained, for example, from petroleum coke, coal coke, celluloses, saccharides, and mesophase pitch; artificial graphites, including pyrolytic graphite; carbon blacks, such as acetylene black, furnace black, Ketjen black, channel black, lamp black, and thermal black; asphalt pitch, coal tar, active carbon, mesophase pitch, and polyacetylenes; carbon nanostructures such as carbon nanotubes; or graphene-based carbon structures.

Based on the findings of the present inventors, a beneficial economic benefit is achieved not just from the substitution of kaolin for the carbon black, but more importantly, through the weight reduction of the barrier material itself. If barrier properties can be maintained or improved, then a significant economic benefit can be gained through weight reduction of the application.

In this detailed description, reference has been made to multiple embodiments of the disclosure and non-limiting examples relating to how the disclosure can be understood and practiced. Other embodiments that do not provide all of the features and advantages set forth herein may be utilized, without departing from the spirit and scope of the present disclosure. This disclosure incorporates routine experimentation and optimization of the methods and systems described herein. Such modifications and variations are considered to be within the scope of the invention defined by the claims.

All publications, patents, and patent applications cited in this specification are herein incorporated by reference in their entirety as if each publication, patent, or patent application were specifically and individually put forth herein.

Where methods and steps described above indicate certain events occurring in certain order, those of ordinary skill in the art will recognize that the ordering of certain steps may be modified and that such modifications are in accordance with the variations of the disclosure. Additionally, certain of the steps may be performed concurrently in a parallel process when possible, as well as performed sequentially.

Therefore, to the extent there are variations of the disclosure, which are within the spirit of the disclosure or equivalent to the inventions found in the appended claims, it is the intent that this patent will cover those variations as well. The present invention shall only be limited by what is claimed.

1. A composition for reducing fluid permeability through a polymer membrane, said composition comprising a polymer and from about 10 to about 100 parts per hundred of mineral particles, wherein said mineral particles include fine mineral particles with particle sizes between about 0.05 μm and about 1 μm and coarse mineral particles with particle sizes between about 3 μm and about 20 μm, and wherein the weight ratio of said fine mineral particles to said coarse mineral particles is selected from about 0.1 to about 10.

2. The composition of claim 1, wherein said composition comprises from about 20 to about 100 parts per hundred of mineral particles.

3. The composition of claim 2, wherein said composition comprises from about 40 to about 70 parts per hundred of mineral particles.

4. The composition of claim 3, wherein said composition comprises from about 50 to about 60 parts per hundred of mineral particles.

5. The composition of claim 1, wherein said weight ratio is selected from about 0.2 to about 10.

6. The composition of claim 5, wherein said weight ratio is selected from about 0.2 to about 5.

7. The composition of claim 6, wherein said weight ratio is selected from about 1 to about 5.

8. The composition of claim 7, wherein said weight ratio is selected from about 2.5 to about 3.5.

9. The composition of claim 1, wherein said weight ratio is selected to balance gas-barrier and strength properties associated with said composition.

10. The composition of claim 1, wherein said coarse mineral particles constrain the movement of said fine mineral particles.

11. The composition of claim 10, wherein said coarse mineral particles limit the ability of said fine mineral particles to rotate in the presence of a shear field.

12. The composition of claim 10, wherein said coarse mineral particles cause alignment of said fine mineral particles.

13. A composition for reducing fluid permeability through a polymer membrane, said composition comprising a polymer and mineral particles, wherein:
said mineral particles possess a bimodal particle-size distribution;
said bimodal particle-size distribution includes a first peak diameter and a first peak population associated with fine mineral particles and a second peak diameter and a second peak population associated with coarse mineral particles;
said first peak diameter is from about 0.05 μm to about 1 μm;
said second peak diameter is from about 3 μm to about 20 μm; and
the weight ratio of said fine mineral particles to said coarse mineral particles is from about 0.1 to about 10.

14. The composition of claim 13, wherein said particle-size distribution is measured by a laser light scattering technique.

15. The composition of claim 13, wherein said particle-size distribution uses the average Stokes-equivalent particle diameters for said fine and coarse mineral particles.

16. The composition of claim 13, wherein said first peak population is larger than said second peak population.

17. The composition of claim 13, wherein said first peak population is smaller than said second peak population.

18. The composition of claim 13, wherein said first peak diameter is in the range of about 0.2 μm to about 0.8 μm.

19. The composition of claim 18, wherein said first peak diameter is in the range of about 0.3 μm to about 0.5 μm.

20. The composition of claim 13, wherein said second peak diameter is in the range of about 5 μm to about 10 μm.

21. The composition of claim 20, wherein said second peak diameter is in the range of about 6.5 μm to about 8.5 μm.

22. The composition of claim 13, wherein said mineral particles have an average calculated specific surface area by laser light in the range of about 1 m²/g to about 5 m²/g or a specific surface area in the range of about 6 m²/g to about 30 m²/g as measured by the BET method.

23. The composition of claim 22, wherein said mineral particles have an average calculated specific surface area by laser light in the range of about 1.5 m²/g to about 3.5 m²/g or a specific surface area in the range of about m²/g 15 to about 30 m²/g as measured by the BET method.

24. The composition of either one of claims 1 or 13, said composition further comprising particles larger than 20 μm.

25. The composition of either one of claims 1 or 13, wherein said mineral particles are clay mineral particles.

26. The composition of either one of claims 1 or 13, wherein said mineral particles are selected from the group consisting of kaolin ball clay, montmorrilite, bentonite, talc, mica, calcite, dolomite, alumina, silica, alumina-silicates, mineral zeolites, pyrophyllite, vermiculite, lime, gypsum, and any polymorph or mixture thereof.

27. The composition of either one of claims 1 or 13, wherein said mineral particles are selected from the Kaolin group of minerals comprising kaolinite, dickite, halloysite, montmorilite, bentonite, nacrite, or any other polymorph of Al₂Si₂O₅(OH)₄.

28. The composition of claim 27, wherein said mineral particles consist essentially of kaolin particles.

29. The composition of either one of claims 1 or 13, wherein said polymer is a thermoset elastomer.

30. The composition of claim 29, wherein said polymer is selected from the group consisting of butyl rubber, halobutyl rubber, nitrile rubber, natural rubber, neoprene rubber, ethylene-propylene-diene-monomer rubber, polybutadiene, poly(styrene-butadiene-styrene), and any combination thereof.

31. The composition of claim 30, wherein said polymer is bromobutyl rubber.

32. The composition of either one of claims 1 or 13, wherein said polymer is a thermoplastic polymer.

33. The composition of claim 32, wherein said polymer is selected from the group consisting of homopolymers or co-polymers of polypropylene, polyethylene, polystyrene, poly(acrylonitrile-butadiene-styrene), poly(methyl methacrylate), poly(vinyl chloride), poly(vinyl acetate), styrene-butadiene block copolymer, polylactide, and any combination thereof.

34. The composition of either one of claims 1 or 13, wherein said polymer is a thermoplastic vulcanizate.

35-39. (canceled)

40. A composition for reducing fluid permeability through a polymer membrane, said composition comprising a bromobutyl polymer, carbon black, and from about 20 to about 100 parts per hundred of mineral particles, wherein said mineral particles include fine mineral particles with particle sizes between about 0.05 μm and about 1 μm and coarse mineral particles with particle sizes between about 3 μm and about 20 μm, and wherein the weight ratio of said fine mineral particles to said coarse mineral particles is selected from about 0.1 to about 10.

41. The composition of claim 40, said composition further comprising stearic acid, magnesium oxide, dimethylalkyl tertiary amine, naphthenic oil, zinc oxide, and sulfur.

42-47. (canceled)

48. A composition comprising a polymer, carbon particles, and from about 40 to about 70 parts per hundred of fine mineral particles with particle sizes between about 0.1 μm and about 1 μm; wherein said composition provides a gas permeability of about 4×10⁻¹³ (cm³·cm/(cm²·sec·Pa)) or less as measured in accordance with ASTM D-1434-82 (2003), Procedure V, using air at a temperature of 70° C., gas pressure of 35 psi, permeation area 66.4 cm², and capillary diameter of 0.0932 cm, on a test sample cured to a gauge of 0.020″ for 10 minutes at 160° C.; and an aged tensile strength of at least 1300 psi as measured in accordance with ASTM D-412 on a test sample cured for 20 minutes at 160° C. and then aged for 48 hours at 100° C. in accordance with ASTM D-573.

49-77. (canceled)
